(19) United States
(12) Patent Application Publication
(10) Pub. No.: US 2006/0179236 A1
(43) Pub. Date: Aug. 10, 2006

(54) System and method to improve hardware pre-fetching using translation hints

(76) Inventor: Hazim Shafi, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/034,552

(22) Filed: Jan. 13, 2005

(51) Int. Cl. G06F 12/14

(52) U.S. Cl. 711/137

(57) ABSTRACT

A system and method for improving hardware-controlled pre-fetching within a data processing system. A collection of address translation entries are pre-fetched and placed in an address translation cache. This translation pre-fetch mechanism cooperates with the data and/or instruction hardware-controlled pre-fetch mechanism to avoid stalls at page boundaries, which improves the latter's effectiveness at hiding memory latency.

(This invention was made with U.S. Government support under NBCH30390004. THE U.S. GOVERNMENT HAS CERTAIN RIGHTS IN THIS INVENTION.)

### BACKGROUND OF THE INVENTION

1. Technical Field

The present invention relates in general to the field of computers, and in particular to accessing computer system memory. Still more particularly, the present invention relates to a system and method for improved speculative retrieval of data stored in system memory.

2. Description of the Related Art

Processors in a multi-processor computer system typically share system memory, which may be in multiple private memories associated with specific processors with non-uniform access latency, or in a centralized memory, in which memory access latency is the same for all processors. Since memory latency continues to increase relative to processor speeds, modern computer architectures continue to employ caches of increasing sizes and levels to reduce the effective memory latency seen by processors by exploiting temporal and spatial locality of accesses. When a processor requires data from memory, it first checks its own private cache hierarchy, which may be organized as a level one (L1) and level two (L2) caches. If the data is not in either local cache, the processor may issue a request for the data to a level three (L3) cache, which may be shared by several processors.

If the requested data is not found in any of the caches, the data is then retrieved from other data storage devices, such as synchronous dynamic random access memory (SDRAM). Although these other data storage devices have higher capacity storage than the cache hierarchy, they have much slower response times. Processors are typically unable to perform enough useful work to overlap the full memory latency of SDRAM, resulting in processors stalls, where processing cycles are wasted while the processor is waiting for requested data.

A way to solve this problem is to initiate pre-fetches. Pre-fetching enables the computer system to determine or speculate what data might be needed for future processing and retrieve that data before it is accessed by the processor. There are two main types of pre-fetching well-known in the art: software-controlled and hardware-controlled pre-fetching. In software-controlled pre-fetching, a compiler (or a human programmer) determines what data to pre-fetch and when to schedule pre-fetch requests. The complier or programmer usually inserts pre-fetch instructions into the code to initiate pre-fetching.

The main advantage of software-controlled pre-fetching is that very little extra hardware is required to implement the pre-fetching. Also, software-controlled pre-fetching can be tailored to a specific program, which reduces unnecessary pre-fetches and maximizes their effectiveness. The main disadvantage of software-controlled pre-fetching is that the software instructions are tailored to specific computer designs. If the software is ported to a different type of computer, the source code must be rewritten and/or recompiled to reflect the latencies in the different computer system. Also, software-controlled pre-fetching requires the computer system to execute extra instructions, which consumes processor cycles and memory bandwidth required to process program data and instructions.

On the other hand, hardware-controlled pre-fetching utilizes hardware that can detect patterns in data accesses at runtime. Hardware-controlled pre-fetching assumes that access in the near future will follow past patterns. Following this assumption, cache blocks containing this data can be pre-fetched into the processor's cache so that later accesses may hit in the cache. Advantageously, hardware-controlled pre-fetching does not require any software support from the programmer or the compiler, does not entail rewriting or recompiling code to take into account the latencies of various computer systems, and does not create additional instruction overhead or code expansion.

However, hardware-controlled pre-fetching requires substantial hardware support, which results in higher hardware manufacturing costs. In addition, the hardware pre-fetching algorithms are fixed, so hardware pre-fetching may not improve memory access latency for code that generates access patterns that the hardware had not anticipated.

Operating systems usually support virtual memory. In such systems, memory is allocated in units called pages. A virtual page in the virtual (or effective) address space is then mapped to a physical page that is allocated out of the physical main memory devices in the system. One consequence of the virtual-to-physical address mapping is that large application data structures that are contiguous in virtual address space are often mapped to non-contiguous physical pages. Since hardware-controlled pre-fetching typically utilizes physical addresses to identify access patterns and perform pre-fetching, such pre-fetching is usually halted at physical page boundaries (e.g., at 4 KB boundaries). To pre-fetch multi-page data structures, multiple pattern identification steps are required, which substantially reduces the effectiveness of the hardware-controlled pre-fetch hardware in hiding memory latency.

### SUMMARY OF THE INVENTION

A system and method for improving hardware-controlled pre-fetching within a data processing system is disclosed. A collection of address translation entries are pre-fetched and placed in an address translation cache. This translation pre-fetch mechanism cooperates with the data and/or instruction hardware-controlled pre-fetch mechanism to avoid stalls at page boundaries, which improves the latter's effectiveness at hiding memory latency.

The above-mentioned features, as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a block diagram of a multi-processor data processing system in which the present invention may be implemented in accordance with a preferred embodiment;

FIG. 2 is a block diagram of a processing unit in accordance with a preferred embodiment of the present invention;

FIG. 3A is a high-level logical flowchart illustrating an exemplary stream identification process in accordance with a preferred embodiment of the present invention;

FIG. 3B is a high-level logical flowchart depicting the operation of an exemplary hardware pre-fetch engine in accordance with a first preferred embodiment of the present invention;

FIG. 3C is a high-level logical flowchart illustrating an exemplary hint processing procedure in accordance with a preferred embodiment of the present invention;

FIG. 3D is a high-level logical flowchart depicting the operation of an exemplary hardware pre-fetch engine in accordance with a second preferred embodiment of the present invention; and

FIG. 4 is a table illustrating a hardware pre-fetch stream data structure in accordance with a preferred embodiment of the present invention.

### DETAILED DESCRIPTION OF THE PREFERRED EMBODIMENT

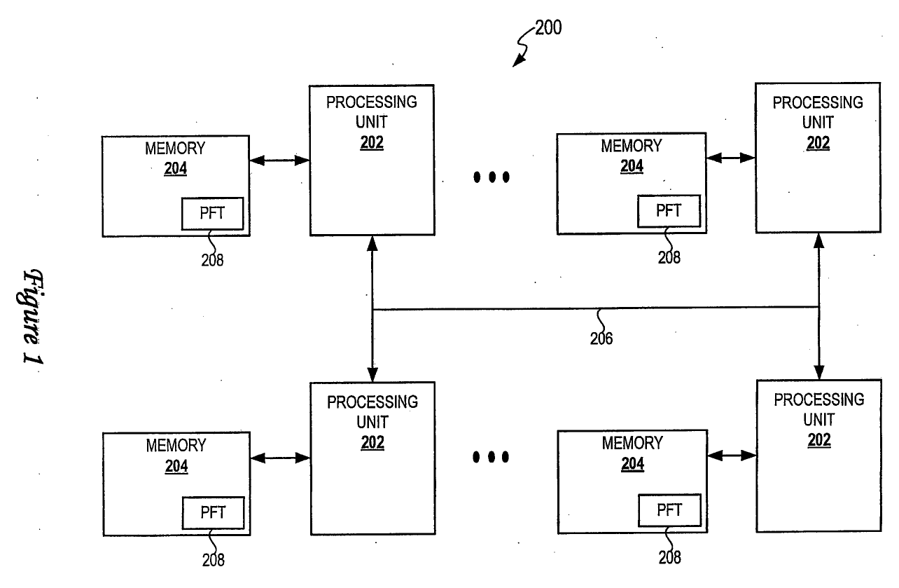

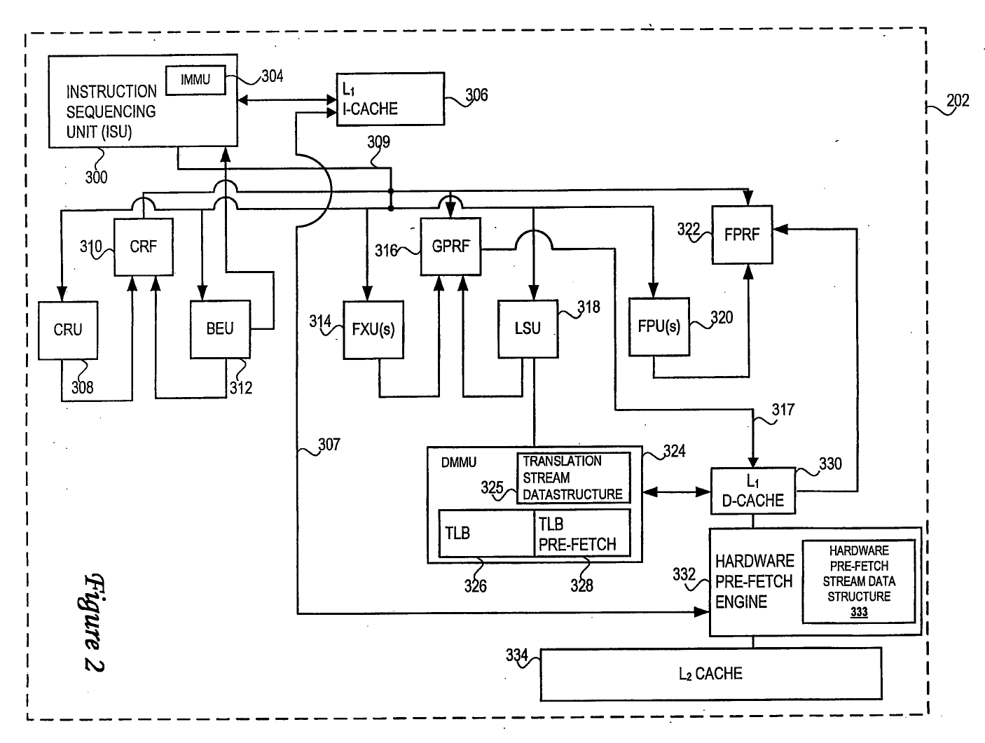

Referring now to FIG. 1, there is depicted a block diagram of a multi-processor data processing system 200 in which a preferred embodiment of the present invention may be implemented. As illustrated, multi-processor data processing system 200 includes multiple processing units 202, which are each coupled to a respective one of memories 204. Each processing unit 202 is further coupled to an interconnect 206 that supports the communication of data, instructions, and control information between processing units 202. Each processing unit 202 is preferably implemented as a single integrated circuit comprising a semiconductor substrate having integrated circuitry formed thereon. Multiple processing units 202 and at least a portion of interconnect 206 may advantageously be packaged together on a common backplane or chip carrier. Page frame tables (PFTs) 208, implemented in memories 204, hold a collection of page table entries (PTEs). The PTEs in PFTs 208 are accessed to translate effective addresses (EAs) employed by software executed within processing units 202 into physical addresses (PAs), as discussed in greater detail below with reference to FIG. 2.

Those skilled in the art will appreciate that multi-processor (MP) data processing system 200 can include many additional components not specifically illustrated in FIG. 1. Because such additional components are not necessary for an understanding of the present invention, they are not illustrated in FIG. 1 or discussed further herein. It should also be understood, however, that the enhancements to speculative retrieval of data provided by the present invention are applicable to data processing systems of any system architecture and are in no way limited to the generalized MP architecture or symmetric multi-processor (SMP) system structure illustrated in FIG. 1.

With reference now to FIG. 2, there is illustrated a detailed block diagram of an exemplary embodiment of a processing unit 202 in accordance with the present invention. As shown, processing unit 202 contains an instruction pipeline including an instruction sequencing unit (ISU) 300 and a number of execution units 308, 312, 314, 318, and 320. ISU 300 fetches instructions for processing from an L1 I-cache 306 utilizing real addresses obtained by the effective-to-real address translation (ERAT) performed by instruction memory management unit (IMMU) 304. Of course, if the requested cache line of instructions does not reside in L1 I-cache 306, then ISU 300 requests the relevant cache line of instructions from L2 cache 334 via I-cache reload bus 307, which is also coupled to hardware pre-fetch engine 332, which includes hardware pre-fetch stream data structure 333, is discussed later in more detail.

After instructions are fetched and preprocessing, if any, is performed, ISU 300 dispatches instructions, possibly out-of-order, to execution units 308, 312, 314, 318, and 320 via instruction bus 309 based upon instruction type. That is, condition-register-modifying instructions and branch instructions are dispatched to condition register unit (CRU) 308 and branch execution unit (BEU) 312, respectively, fixed-point and load/store instructions are dispatched to fixed-point unit(s) (FXUs) 314 and load-store unit(s) (LSUs) 318, respectively, and floating-point instructions are dispatched to floating-point unit(s) (FPUs) 320.

After possible queuing and buffering, the instructions dispatched by ISU 300 are executed opportunistically by execution units 308, 312, 314, 318, and 320. Instruction “execution” is defined herein as the process by which logic circuits of a processor examine an instruction operation code (opcode) and associated operands, if any and in response, move data or instructions in the data processing system (e.g., between system memory locations, between registers or buffers and memory, etc.) or perform logical or mathematical operations on the data. For memory access (i.e., load-type or store-type) instructions, execution typically includes calculation of a target effective address (EA) from instruction operands.

During execution within one of execution units 308, 312, 314, 318, and 320, an instruction may receive input operands, if any, from one or more architected and/or rename registers within a register file coupled to the execution unit. Data results of instruction execution (i.e., destination operands), if any, are similarly written to instruction-specified locations within the register files by execution units 308, 312, 314, 318, and 320. For example, FXU 314 receives input operands from and stores destination operands (i.e., data results) to a general-purpose register file (GPRF) 316, FPU 320 receives input operands from and stores destination operands to a floating-point register file (FPRF) 322, and LSU 318 receives input operands from GPRF 316 and causes data to be transferred between L1 D-cache 330 (via interconnect 317) and both GPRF 316 and FPRF 322. Similarly, when executing condition-register-modifying or condition-register-dependent instructions, CRU 308 and BEU 312 access control register file (CRF) 310, which in a preferred embodiment includes a condition register, link register, count register, and rename registers of each. BEU 312 accesses the values of the condition, link and count registers to resolve conditional branches to obtain a path address, which BEU 312 supplies to instruction sequencing unit 300 to initiate instruction fetching along the indicated path. After an execution unit finishes execution of an instruction, the execution unit notifies instruction sequencing unit 300, which schedules completion of instructions in program order and the commitment of data results, if any, to the architected state of processing unit 202.

Still referring to FIG. 2, a preferred embodiment of the present invention preferably includes a data memory management unit (DMMU) 324. DMMU 324 translates effective addresses (EA) in program-initiated load and store operations received from LSU 318 into physical addresses (PA) utilized to access the volatile memory hierarchy comprising L1 D-cache 330, L2 cache 334, and system memories 206. DMMU 324 includes a translation stream data structure 325, a translation lookaside buffer (TLB) 326, and a TLB pre-fetch engine 328.

TLB 326 buffers copies of a subset of Page Table Entries (PTEs), which are utilized to translate effective addresses, (EAs) employed by software executing within processing units 202 into physical addresses (PAs). As utilized herein, an effective address (EA) is defined as an address that identifies a memory storage location or other resource mapped to a virtual address space. A physical address (PA), on the other hand, is defined herein as an address within a physical address space that identifies a real memory storage location or other real resource.

TLB pre-fetch engine 328 examines TLB 326 and translation stream data structure 325 to determine the recent translations needed by LSU 318 and to speculatively retrieve into TLB 326 PTEs from PFT 208 that may be needed for future transactions. By doing so, TLB pre-fetch engine 328 eliminates the substantial memory access latency associated with TLB misses that are avoided through speculation.

TLB pre-fetch engine 328 also examines TLB 326 and translation stream data structure 325 for consecutively requested EA-to-PA translations in which the two effective addresses of the translations span the boundary between different physical memory pages or regions. The physical address pairs are sent to hardware pre-fetch engine 332 as a hint. Utilizing the hint, hardware pre-fetch engine 332 can transition directly from a first page represented by the first physical address in the hint to a second page represented by the second physical address in the hint during pre-fetching. This transition avoids the latency penalty involved with pre-fetching on the first page until reaching a page boundary, waiting for cache misses to the physical address to the second page to identify a new stream, and restarting pre-fetching on the second page.

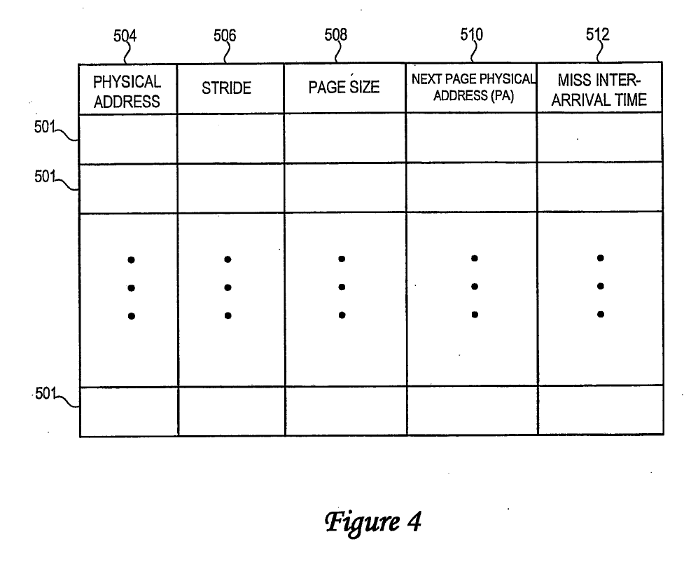

As depicted in FIG. 4, hardware pre-fetch stream data structure 333 stores information regarding data pre-fetch streams of DMMU 324. Hardware pre-fetch stream data structure 333 includes a plurality of entries 501, each containing information describing a respective pre-fetch stream. In the depicted embodiment, each entry 501 preferably includes five fields. Physical address field 504 indicates a physical address of the present stream. Stride field 506 indicates the stride in which hardware pre-fetch engine 332 pre-fetches data, starting at the physical address listed in physical address field 504. Page size field 508 indicates the size of the page corresponding to the physical address listed in physical address field 504. Next page field 510 indicates the physical address corresponding to the next page to which hardware pre-fetch engine 332 should transition after a physical page boundary has been reached. Miss inter-arrival time field 512 indicates the delay that hardware pre-fetch engine 332 should wait before pre-fetching at the next address in the stream indicated by entry 501.

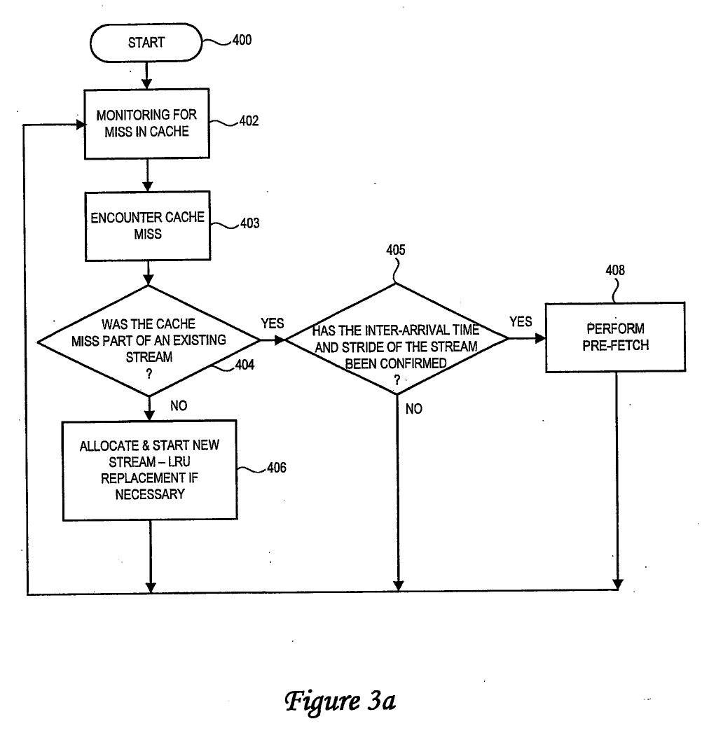

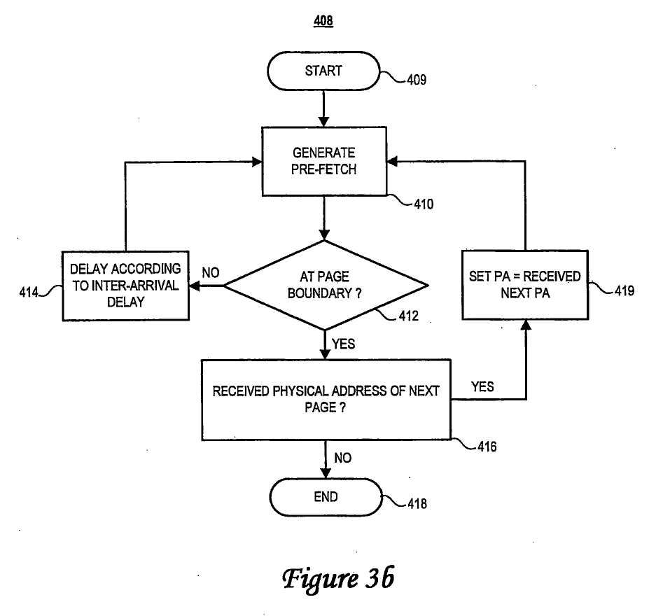

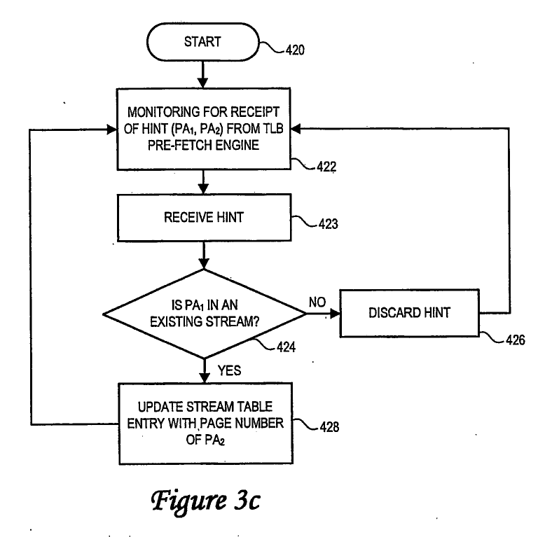

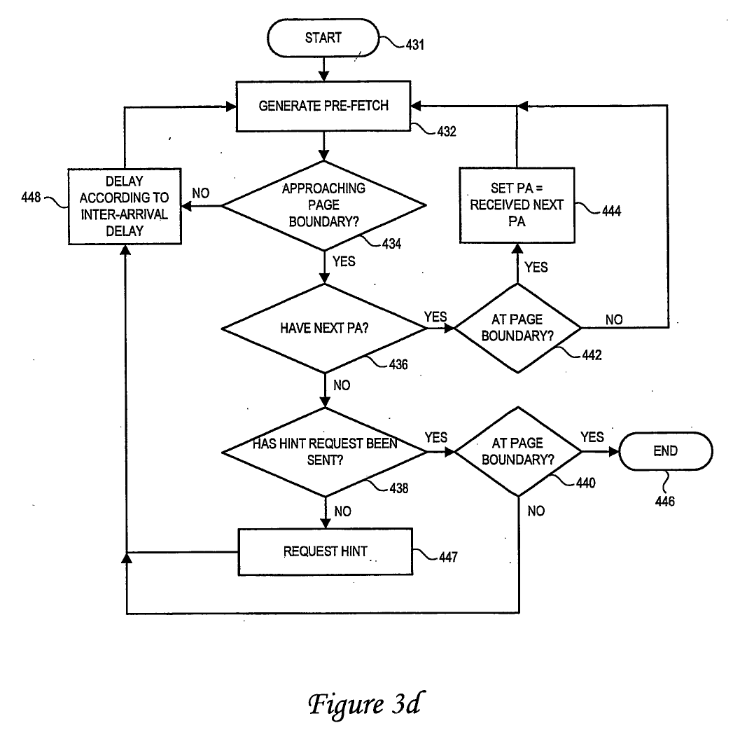

Referring now to FIG. 3A, there is depicted a high-level logical flowchart of an exemplary stream identification process according to a preferred embodiment of the present invention. The process begins at step 400 and continues to step 402, which illustrates hardware pre-fetch engine 332 monitoring L1 D-cache 330 for a cache miss. Then, the process continues to step 403, which depicts hardware pre-fetch engine 332 detecting a cache miss in L1 D-cache 330. The process then proceeds to step 404, which illustrates hardware pre-fetch engine 332 determining whether or not the cache miss address is part of an existing stream stored in hardware pre-fetch stream data structure 333. If hardware pre-fetch engine 332 determines that the cache miss address does not belong to an existing stream stored in hardware pre-fetch stream data structure 333, the process moves to step 406, which illustrates hardware pre-fetch engine 332 allocating and initiating a new stream in hardware pre-fetch stream data structure 333. If necessary, when hardware pre-fetch stream data structure 333 is full, hardware pre-fetch stream data structure 333 preferably utilizes a least-recently used or other replacement algorithm to replace the entry 501 describing a selected stream with another entry 501 describing a newly-allocated stream. The process then returns to step 402 and continues in an iterative fashion.

Returning to step 404, if hardware pre-fetch engine 328 determines that the cache miss address belongs to an existing stream having a corresponding entry 501 stored in hardware pre-fetch stream data structure 325, the process continues to step 405, which depicts hardware pre-fetch engine 328 determining whether or not the inter-arrival time and stride of the existing stream has been confirmed. Because the time for pre-fetches of instruction and/or data may be varied depending on when the specific instructions and/or data may be needed for processing, pre-fetches starting at a physical address may be varied by hardware pre-fetch engine 332 by a value called the inter-arrival time. This value is confirmed by hardware pre-fetch engine 332 by analyzing the frequencies of cache misses starting at a specific physical address (PA). However, at least two cache misses starting at the same physical address (PA) before a time interval between the misses can be calculated by hardware pre-fetch engine 332. Therefore, it is possible for an existing stream entry 501 to be missing a value in miss inter-arrival time field 512 because a second cache miss has not yet occurred.

Returning to step 405, if the inter-arrival time and stride of the existing stream has been confirmed, the process continues to step 408, which illustrates hardware pre-fetch engine 328 performing the pre-fetch, which is discussed in more detail in FIGS. 3B and 3D. The process then returns to step 402 and continues in an iterative fashion. However, if the inter-arrival time and stride of the existing stream has not been confirmed, the process returns to step 402 and continues in an iterative fashion.

With reference now to FIG. 3B, there is illustrated a high-level logical flowchart of a more detailed representation of the operation of hardware pre-fetch engine 332 in accordance to a first preferred embodiment of the present invention. The operation of hardware pre-fetch engine 332 is performed for each stream represented by each entry 501 in hardware pre-fetch stream data structure 333. The process begins at step 409, in response to hardware pre-fetch engine 332 determining that the cache miss address is part of an existing stream, as depicted in step 404 in FIG. 3A. The process then continues to step 410, which illustrates hardware pre-fetch engine 332 generating a pre-fetch. This pre-fetch is generated because the cache miss address is L1 D-cache 330 was determined by hardware pre-fetch engine 332 to be part of an existing stream stored in hardware pre-fetch stream data structure 333, as illustrated in step 404.

Then, the process moves to step 412, which illustrates hardware pre-fetch engine 332 determining whether or not a page boundary has been reached. In one embodiment, hardware pre-fetch engine 332 makes this determination by performing a logical AND of the physical address of the current location being pre-fetched and a sequence of ones. If the result of the calculation is all zeros, hardware pre-fetch engine 332 has encountered a page boundary. If hardware pre-fetch engine 332 determines that a page boundary has not been reached, the process moves to step 414, which depicts hardware pre-fetch engine 332 delays processing for the length of time indicated in a miss inter-arrival delay field 512 corresponding to entry 501 in translation stream data structure 325 in FIG. 4. The process then proceeds to step 410 and continues in an iterative fashion.

If hardware pre-fetch engine 332 determines that a page boundary has been reached, the process continues to step 416, which depicts hardware pre-fetch engine 332 determining whether or not the physical address (PA) of the next page has been received from TLB pre-fetch engine 328. The next physical address is preferably provided by TLB pre-fetch engine 328 in the form of a hint. Hint processing is discussed in detail with reference with FIG. 3C. If the physical address (PA) of the next page has been received from TLB pre-fetch engine 328, the process continues to step 419, which illustrates hardware pre-fetch engine 332 setting the present physical address (PA) to be pre-fetched equal to the next physical address (PA) received from TLB pre-fetch engine 328 in the form of a hint. The process then proceeds to step 410 and continues in an iterative fashion.

However, if hardware pre-fetch engine 332 has not received the physical address (PA) of the next page, the process continues to step 418, which illustrates the process ending at the page boundary. The pre-fetching stops at the page boundary because if hardware pre-fetch engine 332 continued to pre-fetch data at the next physical page stored in memory, much of the data pre-fetched would be unnecessary data that merely wasted space in the cache.

Now referring to FIG. 3C, there is depicted a high-level logical flowchart of the hint processing procedure in accordance with a preferred embodiment of the present invention. As depicted, the process begins at step 420 and proceeds to step 422, which illustrates hardware pre-fetch engine 332 monitoring for a hint from TLB pre-fetch engine 422 has been received.

A hint includes two physical addresses: physical address 1 (PA₁) and physical address 2 (PA₂). PA, represents a physical address of a first memory page and PA₂ represents a physical address of a second, separate memory page. Hardware pre-fetch engine 332 may require pre-fetching of data from both of the memory pages. By receiving both physical addresses as a hint, hardware pre-fetch engine 332 may transition from the first memory page to the second memory page without consuming extra bandwidth and processor cycles required to identify a new stream associated with the second physical address when reaching the boundary of the first memory page.

The hint provision of TLB pre-fetch engine 328 also allows for more accurate pre-fetching of speculative data by the hardware pre-fetch engine 332. As discussed above, processing unit 202 usually requests data by referencing the data's location through an effective address (EA). However, the EA must be translated to an actual physical location (PA) on the cache. Memory pages that have contiguous EAs may not necessarily have contiguous PAs. Therefore, once hardware pre-fetch engine 332 reaches a page boundary of a memory page, the result of hardware pre-fetch engine 332 transitioning to the next page in physical memory is that the cache storing the pre-fetched data would be filled with irrelevant data.

Then, the process continues to step 423, which illustrates hardware pre-fetch engine 332 receiving a hint from TLB pre-fetch engine 328. The process then continues to step 424, which depicts hardware pre-fetch engine 332 determining if the first physical address (PA₁) in the hint is part of an existing stream recorded in translation stream data structure 325. If the first physical address (PA₁) is not in any existing stream described in an entry 501 of in hardware pre-fetch stream data structure 333, the process moves to step 426, which depicts hardware pre-fetch engine 332 discarding the hint. The process then returns to step 422 and proceeds in an iterative fashion.

However, if hardware pre-fetch engine 332 determines that the first physical address (PA₁) in the hint is in an existing stream recorded in hardware pre-fetch stream data structure 333, the process continues to step 428, which illustrates hardware pre-fetch engine 332 updating hardware pre-fetch stream data structure 333 entry. Entry 501, in FIG. 5 includes a next physical address field 510 that indicates to hardware pre-fetch engine 322 the physical address corresponding to the next memory page on which data should be pre-fetched by hardware pre-fetch engine 332. The process then returns to step 422 and proceeds in an iterative fashion.

Referring now to FIG. 3D, there is illustrated a high-level logical flowchart of a more detailed representation of the operation of hardware pre-fetch engine 332 in accordance to a second preferred embodiment of the present invention. The operation of hardware pre-fetch engine 332 depicted in FIG. 3D is performed for each stream represented by each entry 501 in hardware pre-fetch stream data structure 333. The process begins at step 431, in response to step 408 of FIG. 3A, where hardware pre-fetch engine 332 determines that the cache miss address was part of an existing stream recorded in hardware pre-fetch stream data structure 333. The process then moves to step 432, which illustrates hardware pre-fetch engine 332 generating a pre-fetch according starting at the physical address (PA) listed in physical address field 504 of entry 501 in hardware pre-fetch stream data structure 333.

Then, the process continues to step 434, which illustrates hardware pre-fetch engine 332 determining whether or not a physical page or region boundary is approaching during pre-fetching of data. In one embodiment, hardware pre-fetch engine 332 makes this determination by performing a logical AND of the physical address of a future location to be pre-fetched and a sequence of ones. If the result of the calculation is all zeros, hardware pre-fetch engine 332 determines that this future pre-fetch location is close to a page boundary. Those skilled in the art will appreciate that the timing of the pre-emptive page boundary calculation can be varied relative to how close to the physical page boundary hardware pre-fetch engine 332 is during the pre-fetching operation.

If hardware pre-fetch engine 332 determines that a page boundary is approaching, the process continues to step 436, which depicts hardware pre-fetch engine 332 determining by reference to next physical address field 510 of the corresponding entry 501 in hardware pre-fetch stream data structure 333 whether or not the next page physical address has been received from TLB pre-fetch engine 328. If hardware pre-fetch engine 332 determines that the next page physical address has been received, the process continues to step 442, which illustrates whether or not hardware pre-fetch engine 332 has encountered a page boundary. If hardware pre-fetch engine 332 has not encountered a page boundary, the process returns to step 432 and continues in an iterative fashion. However, if hardware pre-fetch engine 332 has encountered a page boundary, the process continues to step 444, which depicts hardware pre-fetch engine 332 setting the current physical address (PA) location equal to the next physical address (PA) location received from TLB pre-fetch engine 328 in the form of a hint. The process then continues to step 432 and proceeds in an iterative fashion.

Returning to step 434, if hardware pre-fetch engine 332 is not approaching a page boundary, the process proceeds to step 448, which illustrates hardware pre-fetch engine 332 delaying for a period of time indicated in miss inter-arrival time field 512 in an entry 501 corresponding to the current stream. Then, the process continues to step 432 and proceeds in an iterative fashion

Returning to step 436, if hardware pre-fetch engine 332 has not received the next physical address (PA) location from TLB pre-fetch engine 328, the process continues to step 438, which illustrates hardware pre-fetch engine 332 determining whether or not a hint request in the form of the current page physical page address (PA) has been sent to TLB pre-fetch engine 328. If the hint has been sent, the process continues to step 440, which depicts hardware pre-fetch engine 332 determining whether or not a page boundary has been reached. If a page boundary has been reached, the process continues to step 446, which illustrates the ending of the process. Therefore, once hardware pre-fetch engine 332 reaches a page boundary of a memory page, the result of hardware pre-fetch engine 332 transitioning to the next page in physical memory is that the cache storing the pre-fetched data would be filled with irrelevant data.

Returning to step 440, if a page boundary has not been reached by hardware pre-fetch engine 332, the process continues to step 448, which illustrates hardware pre-fetch engine 332 delaying pre-fetching at the next address in the stream represented by an entry 501 by the value indicated in miss inter-arrival time field 512. The process then continues to step 432 and continues in an iterative fashion.

Returning to step 438, if hardware pre-fetch engine 332 determines that a hint has not been sent from TLB pre-fetch engine 328, the process continues to step 447, which illustrates hardware pre-fetch engine 332 requesting a hint from TLB pre-fetch engine 328 in the form of the current address of the current memory page so that the TLB pre-fetch engine 328 can perform a reverse PA-to-EA lookup utilizing translation stream data structure 325, identify the EA stream, and look up the translation of the next effective address page, and then send the physical address associated with that second page to the hardware pre-fetch engine 332. The process then proceeds to step 448 and continues in an iterative fashion.

As has been described, the present invention is a system and method of improving hardware-controlled pre-fetch engines by cooperating with a translation pre-fetch engine. A TLB (or translation) pre-fetch engine speculatively retrieves page table entries utilized for effective-to-physical address translation from a page frame table and places the entries into a TLB (translation lookaside buffer). The TLB pre-fetch engine also examines the TLB translation requests for contiguous effective addresses residing in separate physical memory pages or regions. The TLB pre-fetch engine then sends the pairs of physical addresses to a hardware pre-fetch engine in the form of a hint, so that the hardware pre-fetch engine can more accurately pre-fetch data. The hint offers the hardware pre-fetch engine a suggestion of a physical page or memory region to which to transition after pre-fetching has completed on the present page

Of course, persons having ordinary skill in this art are aware that while this preferred embodiment of the present invention offers an improved system and method of pre-fetching data in L1 D-cache (data cache) 330, the present invention may be implemented to handle improved pre-fetching in instruction caches, such as exemplary L1 I-cache 306. In fact, instruction sequencing unit (ISU) 300 may also include a TLB 326 and TLB pre-fetch engine 328 to handle improved pre-fetching in L1 I-cache 306. Also, it should be understood that at least some aspects of the present invention may alternatively implemented in a program product. Programs defining functions on the present invention can be delivered to a data storage system or a computer system via a variety of signal-bearing media, which include, without limitation, non-writable storage media (e.g., CD-ROM), writable storage media (e.g., floppy diskette, hard disk drive, read/write CD-ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

What is claimed is:

1. A processor, comprising:
a data pre-fetcher that pre-fetches data; and
a translation pre-fetcher that pre-fetches a plurality of translation entries, generates at least one hint of a memory region likely to be accessed and communicates said at least one hint to said data pre-fetcher, wherein said data pre-fetcher utilizes said at least one hint to perform pre-fetching of said data.

2. The processor in claim 1, further comprises:
an address translation cache, wherein said translation pre-fetcher stores said plurality of translation entries.

3. The processor in claim 1, wherein said at least one hint further comprises:
a plurality of physical addresses, wherein each of said plurality of physical addresses are located on separate memory regions.

4. The processor in claim 1, further comprising:
a hardware pre-fetch stream data structure for storing pre-fetch streams that include at least a first physical address, a second physical address, and a stride that indicates a step-size utilized by said data pre-fetcher during said pre-fetching of said data.

5. A data processing system, comprising:
a plurality of processors, in accordance with claim 1;
a memory; and
an interconnect coupling said memory and said plurality of processors.

6. The data processing system in claim 5, wherein said plurality of processors further comprise:
an address translation cache, wherein said translation pre-fetcher stores said plurality of translation entries.

7. The data processing system in claim 5, wherein said at least one hint further comprises:
a plurality of physical addresses, wherein each of said plurality of physical addresses are located on separate memory regions.

8. The data processing system in claim 5, wherein said plurality of processors further comprise:
a hardware pre-fetch stream data structure for storing pre-fetch streams that include at least a first physical address, a second physical address, and a stride that indicates a step-size utilized by said data pre-fetcher during said pre-fetching of said data.

9. A multi-chip module, with a plurality of processors in accordance with claim 1, wherein
said plurality of processors further comprise:
a data pre-fetcher that pre-fetches data; and
a translation pre-fetcher that pre-fetches a plurality of translation entries, generates at least one hint of a memory region likely to be accessed and communicates said at least one hint to said data pre-fetcher, wherein said data pre-fetcher utilizes said at least one hint to perform pre-fetching of said data.

10. The multi-chip module in claim 9, wherein said plurality of processors further comprise:
an address translation cache, wherein said translation pre-fetcher stores said plurality of translation entries.

11. The multi-chip module in claim 1, wherein said at least one hint further comprises:
a plurality of physical addresses, wherein each of said plurality of physical addresses are located on separate memory regions.

12. The multi-chip module in claim 1, wherein said plurality of processors further comprise:
a hardware pre-fetch stream data structure for storing pre-fetch streams that include at least a first physical address, a second physical address, and a stride that indicates a step-size utilized by said data pre-fetcher during said pre-fetching of said data.

13. A method of speculatively retrieving data from a data processing system, said method comprising:
pre-fetching a plurality of translation entries;
generating at least one hint of a memory region likely to be accessed; and
communicating said at least one hint to a data pre-fetcher, wherein said pre-fetcher utilizes said at least one hint to perform pre-fetching of said data.

14. The method in claim 13, further comprising:
storing said plurality of translation entries in an address translation cache.

15. The method in claim 13, wherein said generating further comprises:
generating at least one hint of a memory region likely to be accessed, wherein said at least one hint further includes a plurality of physical address, wherein each of said plurality of physical addresses are located on separate memory regions.

16. The method in claim 13, further comprising:
storing pre-fetch streams that include at least a first physical address, a second physical address, and a stride that indicates a step-size utilized by said data pre-fetcher during said pre-fetching of said data.

17. A computer program product, comprising:
code when executed emulates a processor pre-fetching a plurality of translation entries;
code when executed emulates a processor generating at least one hint of a memory region likely to be accessed; and
code when executed emulates a processor communicating said at least one hint to a data pre-fetcher, wherein said pre-fetcher utilizes said at least one hint to perform pre-fetching of said data.

18. The computer program product in claim 17, further comprising:
code when executed emulates a processor storing said plurality of translation entries in an address translation cache.

19. The computer program product in claim 17, wherein said code when executed emulates a processor generating further comprises:
code when executed emulates a processor generating at least one hint of a memory region likely to be accessed, wherein said at least one hint further includes a plurality of physical address, wherein each of said plurality of physical addresses are located on separate memory regions.

20. The computer program produce in claim 17, further comprising:
code when executed emulates a processor storing pre-fetch streams that include at least a first physical address, a second physical address, and a stride that indicates a step-size utilized by said data pre-fetcher during said pre-fetching of said data.
